(19) United States
(12) Patent Application Publication
(10) Pub. No.: US 2025/0015365 A1
(43) Pub. Date: Jan. 9, 2025

(54) RECHARGEABLE BATTERY WITH AN SEI PROTECTIVE LAYER ON THE SURFACE OF A METAL ANODE AND METHOD FOR MAKING SAME

(71) Applicants: International Business Machines Corporation, Armonk, NY (US); Central Glass Co., Ltd., Tokyo (JP)

(72) Inventors: Maxwell Giammona, Fremont, CA (US); Yumi Kim, San Jose, CA (US); Andy Theodora Tek, San Jose, CA (US); Holt Bui, San Jose, CA (US); Young-hye Na, San Jose, CA (US); Murtaza Zohair, San Jose, CA (US); Rei Tsukazaki, Kanagawa (JP); Tsubasa Itakura, Miyoshi (JP); Katsutoshi Suzuki, Tokyo (JP); Kazunari Takeda, Tsurugashima (JP)

(21) Appl. No.: 18/217,966

(22) Filed: Jul. 3, 2023

(51) Int. Cl. H01M 10/42; H01M 10/0569

(52) U.S. Cl. CPC H01M 10/4235; H01M 10/0569; H01M 2300/0037

(57) ABSTRACT

A rechargeable battery has a metal anode with a solid electrolyte interphase (SEI) surface layer, a cathode with a halogen species integrated in a porous carbon material, an electrolyte with an organic solvent and a salt that is in contact with the anode and the cathode, and an oxidizing gas in contact with the electrolyte. The SEI layer has the composition M_{α}B_{β}C_{γ}N_{δ}F_{ε}X_{ζ}O_{η}, where M is a metal, B is boron, C is carbon, N is nitrogen, F is fluorine, X is a non-fluorine halogen species, and O is oxygen; α is a number in the range of 0.2-0.4, β is a number in the range of 0.0-0.1, γ is a number in the range of 0.15-0.25, δ is a number in the range of 0.0-0.02, ε is a number in the range of 0.0-0.1, ζ is a number in the range of 0.005-0.02, η is a number in the range of 0.40-0.60, and α, β, γ, δ, ε, ζ, and η are selected such that the sum of α+β+γ+δ+ε+ζ+η=1. The SEI surface layer on the metal anode suppresses the formation of dendrites, facilitates the even plating of lithium, limits electrolyte decomposition, and extends battery life.

The subject matter of this disclosure describes activities undertaken within the scope of a joint research agreement that was in place before the effective date of the instant application. The parties to the joint research agreement are International Business Machines Corporation (Armonk, New York, USA) and Central Glass Co., Ltd. (Tokyo, Japan).

### TECHNICAL FIELD

The present invention relates generally to rechargeable batteries and more specifically to a rechargeable battery with a protective solid-electrolyte interphase (SEI) layer on the surface of a metal anode that suppresses the formation of dendrites, facilitates the even plating of lithium, limits electrolyte decomposition, and extends battery life.

### BACKGROUND OF THE INVENTION

Rechargeable batteries are in high demand for a wide range of applications, from small batteries for industrial and medical devices, to larger batteries for electric vehicles (EVs) and grid energy storage system, where each application requires a specific set of electrochemical performance characteristics. In many critical and growing application species, such as EVs, battery performance is still considered a major limiting factor for satisfying the high standard of performance to meet the needs of consumers.

Two types of rechargeable batteries are currently of topic in both industry and academia: the first are batteries that run via the electrochemical intercalation/de-intercalation behavior of acting ions and the second are batteries that run via the conversion reaction of active electrode/electrolyte materials. The most widely used rechargeable batteries, setting aside the lead-acid batteries used in internal combustion vehicles, are lithium-ion batteries (LIBs). Currently used commercial LIBs have a metal oxide or metal phosphate-based lithium intercalation material as a positive electrode, a carbon-graphite based intercalation material as a negative electrode, and a liquid electrolyte, where lithium ions move through the liquid electrolyte between the two electrodes as the battery is charged and discharged. Despite the rapid growth and success of LIBs, there remain several shortcomings to be overcome to meet the rapidly increasing demand in the marketplace for high performance batteries.

Lithium-metal has attracted interest as an anode material due to its high theoretical specific capacity of 3860 mAh/g, which is over 10 times higher than the 372 mAh/g specific capacity of graphite; however, there are several issues that must be overcome before lithium metal anodes can be incorporated into commercial batteries. First, current lithium metal anodes exhibit uneven lithium plating that leads to the formation of dendrites. As is well known in the art, dendrites cause battery cells to short-circuit, which can lead to cell fires. Second, uneven lithium deposition can lead to pieces of lithium disconnecting from the anode and thus, no longer contributing to the useable capacity of the device. Accordingly, there remains a need in the art for improved lithium metal anodes for rechargeable batteries.

### SUMMARY OF THE INVENTION

The present invention overcomes the need in the art with a rechargeable battery comprising a metal anode that includes a solid electrolyte interphase (SEI) protection layer comprised of a chemical composition that suppresses the formation of dendrites, facilitates the even plating of lithium, limits electrolyte decomposition, and extends battery life.

In one embodiment, the present invention relates to a rechargeable battery comprising: a metal anode; a cathode; an electrolyte in contact with the anode and the cathode; and a solid electrolyte interphase (SEI) layer on a surface of the metal anode, wherein the SEI layer has a composition according to Formula (1),

M_{α}B_{β}C_{γ}N_{δ}F_{ε}X_{ζ}O_{η}, (1)

wherein, M is a metal, B is boron, C is carbon, N is nitrogen, F is fluorine, X is a non-fluorine halogen, and O is oxygen, α is a number in the range of 0.2-0.4, β is a number in the range of 0.001-0.1, γ is a number in the range of 0.15-0.25, δ is a number in the range of 0.0-0.02, ζ is a number in the range of 0.0-0.1, ζ is a number in the range of 0.005-0.02, η is a number in the range of 0.40-0.60, and α, β, γ, δ, ε, ζ, and η are selected such that the sum of α+β+γ+δ+ε+ζ+η=1.

In another embodiment, the present invention relates to a method of fabricating a rechargeable battery comprising: assembling a battery stack in the presence of an oxidizing gas, wherein the battery stack comprises, a metal anode, a cathode, wherein a surface of the metal anode faces a surface of the cathode, and an electrolyte comprising an organic solvent and a salt, wherein the electrolyte is in contact with the facing surfaces of the metal anode and the cathode; sealing the battery stack within a battery cell case to form the rechargeable battery; and introducing an electric current to the rechargeable battery, wherein initial charge of the rechargeable battery forms a solid-electrolyte interphase (SEI) layer on the surface of the metal anode facing the surface of the cathode, wherein the SEI layer has a composition according to Formula (1),

M_{α}B_{β}C_{γ}N_{δ}F_{ε}X_{ζ}O_{η}, (1)

wherein, M is a metal, B is boron, C is carbon, N is nitrogen, F is fluorine, X is a non-fluorine halogen species, and O is oxygen, α is a number in the range of 0.2-0.4, β is a number in the range of 0.001-0.1, γ is a number in the range of 0.15-0.25, δ is a number in the range of 0.0-0.02, ζ is a number in the range of 0.0-0.1, ζ is a number in the range of 0.005-0.02, η is a number in the range of 0.40-0.60, and α, β, γ, δ, ε, ζ, and η are selected such that the sum of α+β+γ+6+δ+ζ+v=1.

In a further embodiment, M is selected from the group consisting of lithium (Li), sodium (Na), potassium (K), calcium (Ca), zinc (Zn), aluminum (Al), vanadium (V), iron (Fe), and combinations thereof.

In another embodiment, X is selected from the group consisting of chlorine (Cl), bromine (Br), iodine (I), astatine (At), and combinations thereof.

In a further embodiment, the present invention relates to a rechargeable battery comprising: a metal anode; a cathode; an electrolyte comprising an organic solvent and a salt, wherein the electrolyte is in contact with a surface of the metal anode and a surface of the cathode; an oxidizing gas in contact with the electrolyte, the metal anode, and the cathode; and a solid electrolyte interphase (SEI) layer on the surface of the metal anode that is in contact with the electrolyte, wherein the SEI layer has a composition according to Formula (2),

Li_{α}B_{β}C_{γ}N_{δ}F_{ε}I_{ζ}O_{η} (2)

wherein, Li is lithium, B is boron, C is carbon, N is nitrogen, F is fluorine, I is iodine, and O is oxygen, α is a number in the range of 0.2-0.4, β is a number in the range of 0.001-0.1, γ is a number in the range of 0.15-0.25, δ is a number in the range of 0.0-0.02, ζ is a number in the range of 0.0-0.1, ζ is a number in the range of 0.005-0.02, η is a number in the range of 0.40-0.60, and α, β, γ, δ, ε, ζ, and η are selected such that the sum of α+β+γ+δ+ε+ζ+η=1.

In another embodiment, the metal anode comprises a metal selected from the group consisting of lithium (Li) sodium (Na), potassrurn (K), rubidrurn (Rb), cesrurn (Cs), francium (Fr) berflium (B3), magnesium (Mg), calcium (Ca), aluminum (Al), and combinations thereof.

In a further embodiment, the cathode comprises a halogen species selected from the group consisting of fluorine (F), chlorine (Cl), bromine (Br), iodine (I), astatine (At), and combinations thereof.

In another embodiment, the halogen species in the cathode is in the form of a metal halide that dissociates into a cation and a halide ion upon solvation.

In a further embodiment, the present invention relates to a rechargeable battery comprising: a lithium anode; a cathode comprising lithium iodide integrated into a porous carbon material selected from the group consisting of carbon cloth, carbon paper, carbon felt, carbon nanotubes, carbon nanotube arrays, carbon fibers, activated carbon, carbon black, graphene, graphene oxide, reduced graphene oxide, 3D graphene skeleton, pyrolytic graphite, and combinations thereof; a liquid electrolyte comprising an organic solvent and a salt, wherein the electrolyte is in contact with a surface of the lithium anode and a surface of the cathode; an oxidizing gas in contact with the electrolyte, the metal anode, and the cathode, wherein the oxidizing gas is selected from the group consisting of air, oxygen, nitric oxide, nitrogen dioxide, and combinations thereof; and a solid electrolyte interphase (SEI) layer on the surface of the metal anode that is in contact with the electrolyte, wherein the SEI has a composition according to Formula (2),

Li_{α}B_{β}C_{γ}N_{δ}F_{ε}I_{ζ}O_{η}, (2)

wherein, Li is lithium, B is boron, C is carbon, N is nitrogen, F is fluorine, I is iodine, and O is oxygen, α is an integer in the range of 0.2-0.4, β is an integer in the range of 0.001-0.1, γ is an integer in the range of 0.15-0.25, δ is an integer in the range of 0.0-0.02, ζ is an integer in the range of 0.0-0.1, η is an integer in the range of 0.005-0.02, η is an integer in the range of 0.40-0.60, and α, β, γ, δ, ε, ζ, and η are selected such that the sum of α++γ+δ+ε+ζ+η=1.

In another embodiment, the present invention relates to a method of fabricating a rechargeable battery comprising: assembling a battery stack in the presence of an oxidizing gas, wherein the battery stack comprises, a lithium anode, a cathode comprising lithium iodide integrated into a porous carbon material, wherein a surface of the metal anode faces a surface of the cathode, and an electrolyte comprising an organic solvent and a salt, wherein the electrolyte is in contact with the facing surfaces of the metal anode and the cathode; sealing the battery stack within a battery cell case to form the rechargeable battery; and introducing an electric current to the rechargeable battery, wherein initial charge of the rechargeable battery forms a solid-electrolyte interphase (SEI) layer on the surface of the metal anode facing the surface of the cathode, wherein the SEI layer has a composition according to Formula (2),

Li_{α}B_{β}C_{γ}N_{δ}F_{ε}I_{ζ}O_{η}, (2)

wherein, Li is lithium, B is boron, C is carbon, N is nitrogen, F is fluorine, I is iodine, and O is oxygen, α is an integer in the range of 0.2-0.4,β is an integer in the range of 0.001-0.1, γ is an integer in the range of 0.15-0.25, δ is an integer in the range of 0.0-0.02, ε is an integer in the range of 0.0-0.1, η is an integer in the range of 0.005-0.02, η is an integer in the range of 0.40-0.60, and α, β, γ, δ, ε, ζ, and η are selected such that the sum of α+β+γ+δ+ε+ζ+η=1.

In a further embodiment, the electrolyte is a liquid electrolyte comprising as least one organic solvent and at least one salt.

In another embodiment, the at least one organic solvent of the liquid electrolyte is selected from the group consisting of 1,2-dimethoxyethane (DME), tetraglyme (G4), 1,3-dioxolane (DOL), tetrahydrofuran (THF), and combinations thereof.

In a further embodiment, the at least one salt of the liquid electrolyte is selected from the group consisting of bis(trifluoromethanesulfonyl)imide (LiTFSI), lithium nitrate (LiNO₃), lithium bis(oxalate)borate (LiBOB), lithium bis(fluorosulfonyl)imide (LiFSI), lithium hexafluorophosphate (LiPF₆), and combinations thereof.

In a further embodiment, the rechargeable battery further comprises an oxidizing gas in contact with the electrolyte, wherein the oxidizing gas is selected from the group consisting of oxygen, air, zero air, carbon dioxide, nitric oxide, nitrogen dioxide, and combinations thereof.

Additional aspects and/or embodiments of the invention will be provided, without limitation, in the detailed description of the invention that is set forth below.

### BRIEF DESCRIPTION OF THE DRAWINGS

FIG. 1 is graph showing the evolution of the atomic percentage of lithium, carbon, and oxygen in a lithium metal surface layer over the first 30 cycles of a device with a lithium metal anode, a lithium iodide cathode, and a liquid electrolyte comprising lithium bis(trifluoromethanesulfonyl)imide (LiTFSI), lithium nitrate (LiNO₃), 1,2-dimethoxyethane (DME), and 1,3-dioxolane (DOL), where the device was sealed under an atmosphere of clean dry air (Comparative Example 1).

FIG. 2 is a graph showing the evolution of the atomic percentage of nitrogen, fluorine, and iodine in a lithium metal surface layer over the first 30 cycles of a device with a lithium metal anode, a lithium iodide cathode, and a liquid electrolyte comprising LiTFSI, LiNO₃, DME, and DOL, where the device was sealed under an atmosphere of clean dry air (Comparative Example 1).

FIG. 3 is a bar graph showing the surface composition of lithium, carbon, nitrogen, oxygen, fluorine, and iodine in a lithium metal surface layer after the first charge of a device with a lithium metal anode, a lithium iodide cathode, and a liquid electrolyte comprising LiTFSI, LiNO₃, DME, and DOL, where the device was sealed under an atmosphere of clean dry air (Comparative Example 1).

FIG. 4 is a bar graph showing the surface composition of lithium, carbon, nitrogen, oxygen, fluorine, and iodine in a lithium metal surface layer after the 30th charge of a device with a lithium metal anode, a lithium iodide cathode, and a liquid electrolyte comprising LiTFSI, LiNO₃, DME, and DOL, and sealed under an atmosphere of clean dry air (Comparative Example 1).

FIG. 5 is a graph showing the capacity retention after 1 min of rest and 24 hrs of rest at open circuit voltage for a hrs. device with a lithium metal anode, a lithium iodide cathode, and a liquid electrolyte comprising LiTFSI, LiNO₃, DME, and DOL, where the device was sealed under an atmosphere of clean dry air (Comparative Example 1).

FIG. 6 is graph showing the evolution of the atomic percentage of lithium, carbon, and oxygen in a lithium metal surface layer over the first 30 cycles of a device with a lithium metal anode, a lithium iodide cathode, and a liquid electrolyte comprising LiTFSI, LiNO₃, DME, and DOL, where the device was cycled under an applied positive pressure of pure O₂ gas with an absolute pressure of ˜1300 torr (Comparative Example 2).

FIG. 7 is a graph showing the evolution of the atomic percentage of nitrogen, fluorine, and iodine in a lithium metal surface layer over the first 30 cycles of a device with a lithium metal anode, a lithium iodide cathode, and a liquid electrolyte comprising LiTFSI, LiNO₃, DME, and DOL, where the device was cycled under an applied positive pressure of pure O₂ gas with an absolute pressure of ˜1300 torr (Comparative Example 2).

FIG. 8 is a bar graph showing the surface composition of lithium, carbon, nitrogen, oxygen, fluorine, and iodine in a lithium metal surface layer after the first charge of a device with a lithium metal anode, a lithium iodide cathode, and a liquid electrolyte comprising LiTFSI, LiNO₃, DME, and DOL, where the device was sealed under an atmosphere of pure oxygen (Comparative Example 2).

FIG. 9 is a bar graph showing the surface composition of lithium, carbon, nitrogen, oxygen, fluorine, and iodine in a lithium metal surface layer after the 30th charge of a device with a lithium metal anode, a lithium iodide cathode, and a liquid electrolyte comprising LiTFSI, LiNO₃, DME, and DOL, where the device was sealed under an atmosphere pure oxygen (Comparative Example 2).

FIG. 10 is graph showing the evolution of the atomic percentage of lithium, carbon, and oxygen in a lithium metal surface layer over the first 280 cycles of a device with a lithium metal anode, a lithium iodide cathode, and a liquid electrolyte comprising LiTFSI, LiNO₃, LIBOB, DME, and DOL, where the device was sealed under an atmosphere of clean dry air (Example 1).

FIG. 11 is graph showing the evolution of the atomic percentage of nitrogen, fluorine, iodine, and boron in a lithium metal surface layer over the first 280 cycles of a device with a lithium metal anode, a lithium iodide cathode, and a liquid electrolyte comprising LiTFSI, LiNO₃, LiBOB, DME, and DOL, where the device was sealed under an atmosphere of clean dry air (Example 1).

FIG. 12 is a bar graph showing the surface composition of lithium, boron, carbon, nitrogen, oxygen, fluorine, and iodine in a lithium metal surface layer after the first charge of a device with a lithium metal anode, a lithium iodide cathode, and a liquid electrolyte comprising LiTFSI, LiNO₃, LiBOB, DME, and DOL, where the device was sealed under an atmosphere of clean dry air (Example 1).

FIG. 13 is a bar graph showing the surface composition of lithium, boron, carbon, nitrogen, oxygen, fluorine, and iodine in a lithium metal surface layer after the 280th charge of a device with a lithium metal anode, a lithium iodide cathode, and a liquid electrolyte comprising LiTFSI, LiNO₃, LiBOB, DME, and DOL, where the device was sealed under an atmosphere of clean dry air (Example 1).

FIG. 14 is a graph showing the capacity retention after 1 min of rest and 24 hrs of rest at open circuit voltage for a hrs. device with a lithium metal anode, a lithium iodide cathode, and a liquid electrolyte comprising LiTFSI, LiNO₃, LiBOB, DME, and DOL, where the device was sealed under an atmosphere of clean dry air (Example 1).

FIG. 15 is a bar graph showing surface composition of a lithium metal surface layer after pretreatment with boric acid/dimethyl sulfoxide (BOH₃/DMSO) solution and cycled under an atmosphere of clean dry air (Example 2).

FIG. 16 is a bar graph showing surface composition of boric acid pretreated lithium metal surface layer after the 10th discharge of a device with a lithium metal anode, iodine cathode, and a liquid electrolyte comprising LiTFSI, LiNO₃, LiBOB, DME, and DOL and sealed under an atmosphere of clean-dry air (Example 2).

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the term “battery” refers to an energy storage device that converts chemical energy into electrical energy. The components of a battery comprise an anode, a cathode, and an electrolyte, which are assembled to form the battery in a “stack” that is contained within a battery case to form a battery cell. The batteries described herein are rechargeable batteries where the stack is sealed within a battery cell case, which may be a button cell (e.g., 303/357; 11.6 mm diameter×5.4 mm height), a coin cell (e.g., CR2032, 20 mm diameter×3.2 mm height), a SWAGELOK® cell (Swagelok Co., Solon, OH, USA), a cylindrical cell (e.g., 18650, 18 mm diameter ×65 mm height), a prismatic cell (rectangular with a steel or aluminum casing), or a pouch cell (typically rectangular with flexible polymer aluminum casing). It is to be understood that in some applications, such as EVs, multiple battery cells may be required to generate sufficient energy to power a device; thus, as used herein, the term “battery cell” may be used to refer to a single battery unit whereas the term “battery” refers more generally to all energy storage devices, including single battery cells and energy storage devices that require multiple battery cells for operation.

As used herein, the term “intercalation” refers to a reaction in an electrode where host atoms form a stationary framework (such as a lattice, layered, olivine, or spinel structure) and (guest) mobile ions or molecules are reversibly incorporated into vacant sites within the framework. The intercalation mechanism minimizes volume change and mechanical strain during repeated insertion and extraction of alkali ions and thus, has good cycling performance. Most commercially available lithium-ion batteries have intercalation electrodes. Intercalation in rechargeable batteries only αcurs during the charging and discharging process and not during an idle state or when the battery is dead. By way of example, in a Li-ion battery with an intercalation cathode with a lattice structure, during discharge, the electroactive species of the cathode material is reduced and Li⁺ is intercalated into available sites in the host lattice. The driving force for intercalation during discharge is the spontaneous redox reaction at the electrode surface where electroneutrality is maintained by the flow of electrons from the negatively charged anode to the positive cathode via the external circuit. When the battery is recharged, an external load reverses the flow of ions and electrons back into the negative electrode.

As used herein, the term “conversion” refers to a reversible redox reaction that αcurs in an electrode during charging and discharging cycles. A conversion electrode is composed of a material that can accommodate insertion and extraction of ions or molecules as the battery charges and discharges. The conversion reaction that αcurs within an electrode changes the chemical composition of the electrode. By way of example, with a conversion cathode, during charging, ions from the anode (the electrode where oxidation αcurs) flows towards the cathode. At the conversion cathode, the ions react with the cathode material causing it to undergo a chemical transformation. The conversion reaction can involve various mechanisms depending on the cathode material that is sued. During charging Li⁺ ions migrate from the anode to the cathode. At the conversion cathode, the metal oxide undergoes a reduction reaction, where the metal atoms in the oxide material capture the lithium ions and convert it into a different compound. The reaction is reversible in that it can αcur during charging and discharging. During discharging, lithium ions are released from the cathode and migrate back to the anode, while the converted compound in the cathode is oxidized back to its original form. By way of example, in the case of cobalt oxide (CoO) (a known conversion cathode material), it is reduced to metallic cobalt (Co) during charging and oxidized back to CoO during discharging. The conversion reaction allows for a high energy storage capacity because the cathode material can accommodate a large number of ions or molecules.

As used herein, the term “anode” refers to the negative electrode of a battery cell that transfers electrons to an external circuit through oxidation during discharging and is reduced (i.e., gains electrons) during charging. Within the context of the rechargeable battery described herein, the anode is a metal anode that includes a metal that may be selected from one or more of the metal groups of the periodic chart, such as Group 1 alkali metals, Group 2 alkali earth metals, Groups 3-12 transition metals and Groups 13-15 post-transitional metals. Exanes of Group 1 alkali metals include lithium (Li), sodium (Na), potassium (K), rubidium (RD), cesium (Cs), and francium. (Fr). Examples of Group 2 alkali earth metals include beryllium (B3), magnesium (Mg), calcium (Ca), strontium (Sr), barium (Ba) and radium (Ra). Examples of Groups 3-12 transition metals include, without limitation, titanium (Ti), vanadium (V), chromium (Cr), manganese (Mn), iron (Fe), cobalt (Co), nickel (Ni), copper (Cu), zinc (Z) yttrium (Y), zirconium (Zr), niobium (Nb), molybdenum (Mo), technetium (Tc), ruthenium (Ru), rhodium (Rh), palladium (pd), silver (Ag), and cadmium (Cd). Examples of Groups 13-15 post-transitional metals include, without limitation, aluminum (Al), gallium (Ga), indium (In), and tin (Sn). Generally, the metal anode will primarily include metals selected from the Group 1 alkali metals and the Group 2 alkali earth metals,

As used herein, the term “cathode” refers to the positive electrode of a battery cell that receives electrons from an external circuit through reduction during discharging and IS oxidized (i.e. loses electrons) during charging. Within the context of the rechargeable battery described herein, the cathode comprises halogen species integrated into a suitable intercalation or conversion cathode material. Examples of intercalation cathode materials include, without limitation, nickel cobalt aluminum (NCA), nickel manganese cobalt (NMC), nickel cobaltite (NiCo₂O₄ or NCO), lithium iron phosphate (LiFePO₄ or LFP), lithium manganese oxide (LMO), lithium cobalt oxide (LiCoO₂), lithium transition-metal oxide (TMO), porous carbon materials, and combinations thereof. Examples porous carbon materials that may comprise the cathode include, without limitation, carbon cloth, carbon paper, carbon felt, carbon nanotubes, carbon nanotube arrays, carbon fibers, activated carbon, carbon black, graphene, graphene oxide, reduced graphene oxide, 3D graphene skeleton, pyrolytic graphite, and combinations thereof. Examples of conversion cathode materials include, without limitation, metal oxides, such as cobalt oxide (CoO), manganese oxide (MnO₂), iron oxide (Fe₂O₃), and copper oxide (CuO); metal sulfides, such as iron sulfide (FeS), copper sulfide (CuS), and molybdenum sulfide (MoS₂); metal fluorides, such as iron fluoride (FeF₃) and copper fluoride (CuF₂); transition metal compounds, such as titanium nitride (TiN), vanadium phosphide (VP), and tungsten carbide (WC); and combinations thereof. Halogen species included in the cathode will be selected from Group 17 of the periodic chart, which includes, without limitation, fluorine (Fj chlorine (Cl), bromine (Br) iodine (I), and astatine (At).

As used herein, the term “electrolyte” refers to a material that facilitates ionic conductivity and cycling between the anode and the cathode in rechargeable batteries. Upon battery charging, an electrolyte facilitates the movement of ions from the cathode to the anode and on discharge, the electrolyte facilitates the movement of ions from the anode to the cathode. Liquid electrolytes generally have at least two components, a solvent and a salt, both of which together facilitate the ionic conductivity and transport.

As used herein the term “solid-electrolyte interphase” or “SEI” refers to a protective ion conductive passivation layer that is formed on the anode surface. The SEI layer is formed in the first battery cycle from the reduction of the electrolyte. The SEI layer allows metal ion transport and prevents further electrolyte decomposition thus extending battery life.

As used herein, the term “oxidizing gas” refers to a gas that induces a redox reaction in a battery cell, Examples of oxidizing gases include, without imitation, oxygen, air, zero air (the mixing of pure oxygen with pure nitrogen) nitric oxide, nitrogen dioxide, carbon dioxide, and combinations thereof. As is known to those of skill in the art, a redox reaction is a reaction that transfers electrons between (i) a reducing agent that undergoes oxidation through the loss of electrons and (ii) an oxidizing agent that undergoes reduction through the gain of electrons. It is to be understood that the oxidizing gas is introduced into battery within the confines of the sealed battery cell where the battery uses the oxidizing gas to induce the redox reaction that runs the battery. Where the oxidizing gas is air, the battery consumes oxygen from the air to run the redox reaction. Within the context of the rechargeable battery described herein, the oxidizing gas works in concert with the electrolyte to form the stable SEI layer on the surface of the metal anode.

As used herein, the term “metal halide” refers to a compound having a metal and a halogen species. The metals of metal halides may be any metal in Groups 1 to 16 of the periodic chart but will typically be Group 1 alkali metals or Group 2 alkali earth metals. Examples of Group 1 alkali metals include, without limitation, lithium (Li), sodium (S), potassium (K) rubidium (Rb), cesium (Cs), and francium (Fr). Examples of Group 2 alkali earth metals include, without limitation, beryllium (Be), magnesium (Mg), calcium (Ca), strontium (Sr), barium (Ba), and radium (Ra). The halides of the metal halides will be any halogen species in Group 17 of the periodic chart, which include, without limitation, fluorine (F, chlorine (Cl), bromine (Br), iodine (I), and astatine (At)

Described herein is a rechargeable battery comprising a metal anode with a stable SEI surface layer that chemically protects the anode, a cathode, and a liquid electrolyte in contact with the metal anode and the cathode. The SEI layer on the surface of the metal anode suppresses the formation of dendrites, facilitates the even plating of lithium, limits electrolyte decomposition, and extends battery life. The SEI layer has a chemical composition according to Formula (1),

M_{α}B_{β}CγN_{δ}F_{ε}X_{ζ}O_{η}, (1)

wherein M is a metal, B is boron, C is carbon, N is nitrogen, F is fluorine, X is a non-fluorine halogen species, and O is oxygen; α is a number in the range of 0.2-0.4, β is a number in the range of 0.001-0.1, γ is a number in the range of 0.15-0.25, δ is a number in the range of 0.0-0.02, ζ is a number in the range of 0.0-0.1, ζ is a number in the range of 0.005-0.02, and ζ is a number in the range of 0.40-0.60; and the sum of α++γ+δ+ε+ζ+η=1.

In one embodiment, the M of the SEI layer is a metal selected from the group consisting of lithium (Li), sodium (Na), potassium (K), calcium (Ca), zinc (Zn), aluminum (Al), vanadium (V), iron (Fe), and combinations thereof. In another embodiment, the X of the SEI layer is a halogen species selected from the group consisting of chlorine (Cl), bromine (Br), iodine (I), astatine (At), and combinations thereof. In a further embodiment, the M of the SEI layer comprises Li and the X of the SEI layer comprises I pursuant to Formula (2),

Li_{α}B_{β}C_{γ}N_{δ}F_{ε}I_{ζ}O_{η}, (2)

wherein, Li is lithium, B is boron, C is carbon, N is nitrogen, F is fluorine, I is iodine, and O is oxygen, α is a number in the range of 0.2-0.4, β is a number in the range of 0.001-0.1, γ is a number in the range of 0.15-0.25, δ is a number in the range of 0.0-0.02, ζ is a number in the range of 0.0-0.1, ζ is a number in the range of 0.005-0.02, η is a number in the range of 0.40-0.60, and α, β, γ, a, ε, ζ, and η are selected such that the sum of α++γ+δ+ε+ζ+η=1.

In another embodiment, the metal anode comprises a Group 1 alkali metal and/or a Group 2 alkali earth metal. Group 1 alkali metals that may be used for the metal anode are selected from the group consisting of Li, sodium (Na), potassium (K), rubidium (Rb, cesium (Cs), francium (Fr) and combinations thereof. Group 2 alkali earth metals that may be used for the metal anode are selected from the group consisting of beryllium (B3), magnesium (Mg) calcium (Ca), aluminum (Al), and combinations thereof.

In a further embodiment, the cathode comprises at least one halogen species incorporated into the cathode material, wherein the halogen species are selected from the group consisting of F, Cl, Br, I, At, and combinations thereof. In another embodiment, the cathode comprises a molecule that dissociates into a cat ion and a halide ion upon solvation. In a further embodiment, the molecule is a metal halide as described herein, wherein the metal halide dissociates into a metal cation and a halide ion upon solvation. In another embodiment, the metal halide is lithium iodide. In a further embodiment, the cathode is an intercalation cathode comprising an intercalation material as described herein. In another embodiment the cathode is a conversion cathode comprising a conversion material as described herein. In a further embodiment, the cathode is an intercalation cathode comprising a porous carbon material with at least one halogen species incorporated therein. Porous carbon materials that may be used for the cathode are selected from the group consisting carbon cloth, carbon paper, carbon felt, carbon nanotubes, carbon nanotube arrays, carbon fibers, activated carbon, carbon black, graphene, graphene oxide, reduced graphene oxide, 3D graphene skeleton, pyrolytic graphite, and combinations thereof.

In another embodiment, the metal of the metal anode and the M of the SEI layer are both Li. In a further embodiment, the halogen species of the cathode and the X of the SEI layer are both I. In another embodiment, the M in the SEI layer and the metal in the metal anode are different. In a further embodiment, the halogen species of the cathode and the X of the SEI layer are different.

In another embodiment, the battery comprises a liquid electrolyte with at least one polar aprotic organic solvent and at least one salt. Examples of polar aprotic organic solvents that may be used in the electrolyte include, without limitation, dichloromethane, 1,2-dimethoxyethane (DME), tetraglyme (G4), 1,3-dioxolane (DOL), tetrahydrofuran (THF), ethyl acetate, acetonitrile, dimethylformamide (DMF), dimethyl sulfoxide (DMSO), acetone, hexamethylphosphoric triamide (HMPA), and combinations thereof. Examples of salts that may be used in the electrolyte include, without limitation, lithium bis(trifluoromethanesulfonyl)imide (LiTFSI), lithium nitrate (LiNO₃), lithium bix(oxalate)-borate (LiBOB), lithium bis(fluorosulfonyl)imide (LiFSI), lithium hexafluorophosphate (LiPF₆), and combinations thereof.

In a further embodiment, the battery comprises an oxidizing gas that is enclosed within the battery cell. While not wishing to be bound by theory, it is believed that the oxygen, or another oxidizing gas, may be infused or incorporated into the cell during cell assembly, and under a dry air environment may react with the metal and the electrolyte molecules at the anode resulting in the formation of the protective SEI passivation layer on the anode surface as described herein.

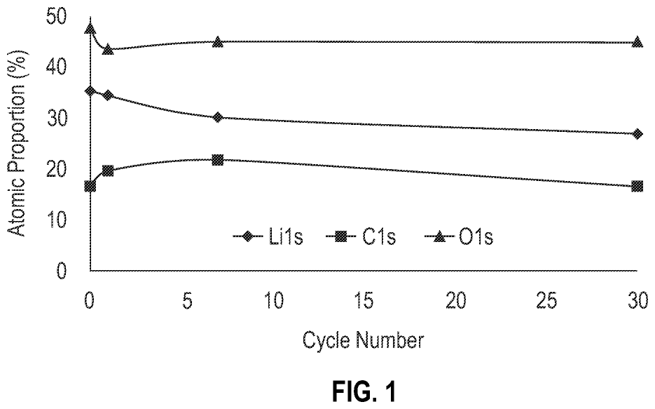

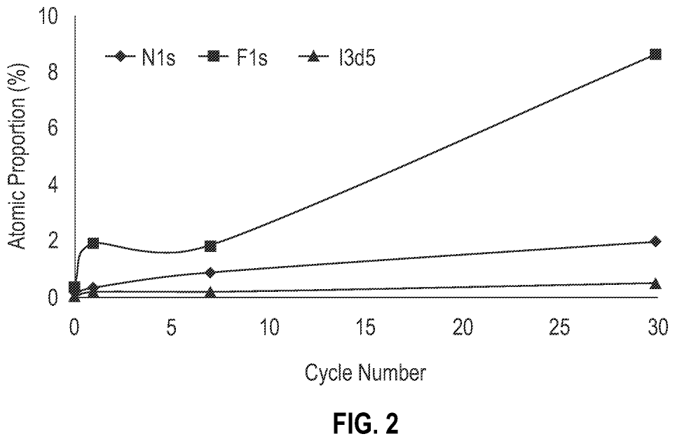

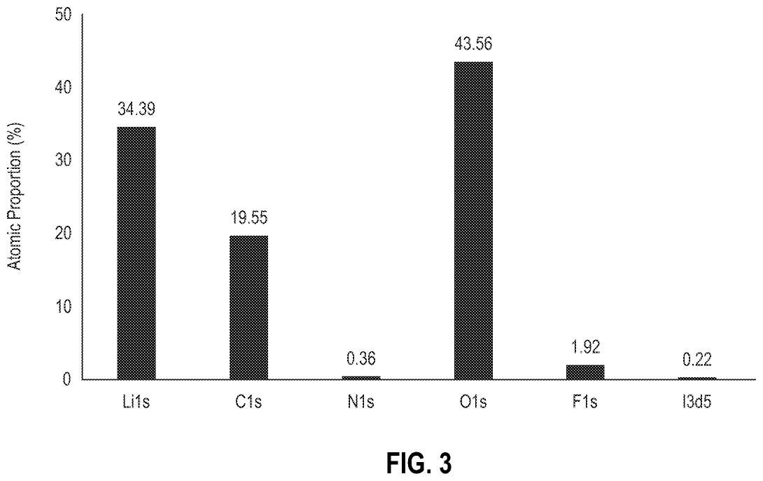

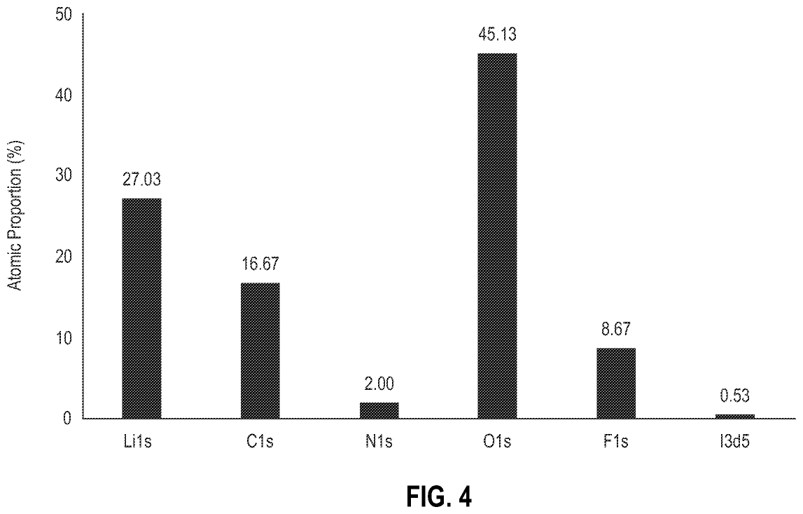

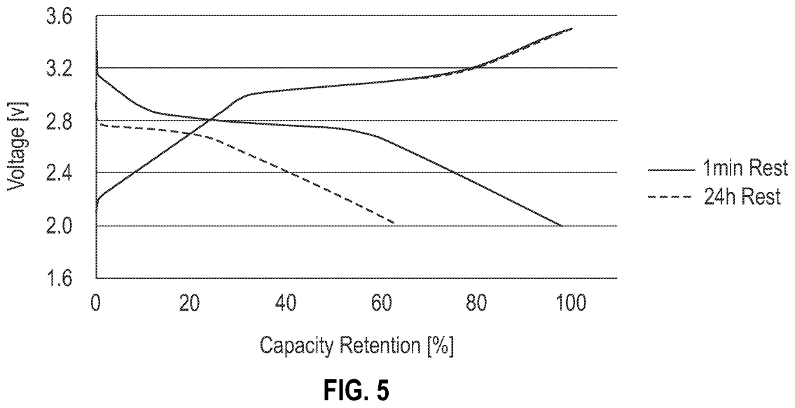

Comparative Example 1 describes the formation of an SEI layer on a Li anode, which is incorporated into a battery cell that is sealed and cycled under clean dry air with an electrolyte solution that includes the organic solvents DME and DOL and the salts LiTFSI and LiNO₃. FIG. 1 shows the atomic proportion of Li, C, and O on the Li anode SEI layer over the course of 30 cycles and FIG. 2 shows the atomic proportion of N, F, and I on the Li anode SEI layer over the course of the same 30 cycles. As shown therein, the atomic proportions of Li, C, O, N, F, and I in the SEI layer on the Li anode surface αcur within the space of Li_{α}CγN_{δ}F_{ε}I_{ζ}O_{η}, where α=0.27-0.35; γ=0.16-0.22; δ=0.001-0.02; ε=0.004-0.09; ζ=0.0003-0.006; and η0.43-0.48. FIG. 3 shows the atomic proportions of Li, C, O, N, F, and I in the SEI layer after the first charge and FIG. 4 shows the atomic proportions of Li, C, O, N, F, and I in the SEI layer after the 30th charge. As shown therein the overall percentages of each of Li, C, O, N, F, and I maintain the same general pattern from the first charge to the 30th charge. FIG. 5 shows the capacity retention of the battery cell after 1 min of rest and 24 hrs of rest at open circuit voltage. As shown therein, the capacity retention of the battery cell is reduced by approximately 20% from 1 minute to 24 hours.

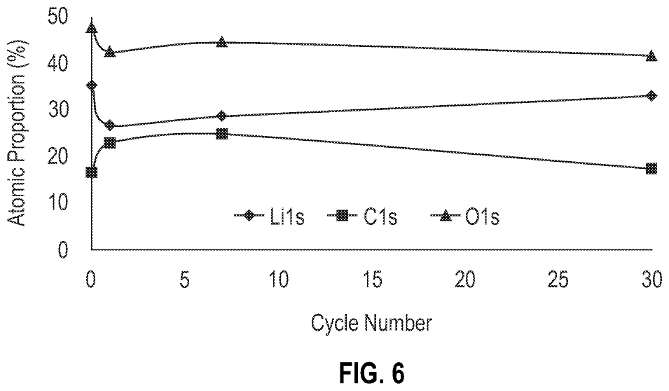

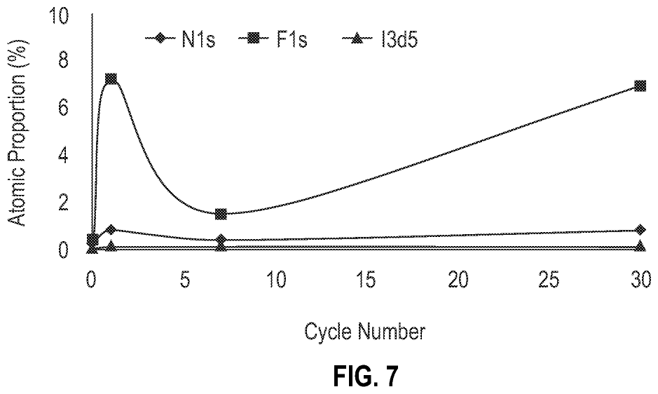

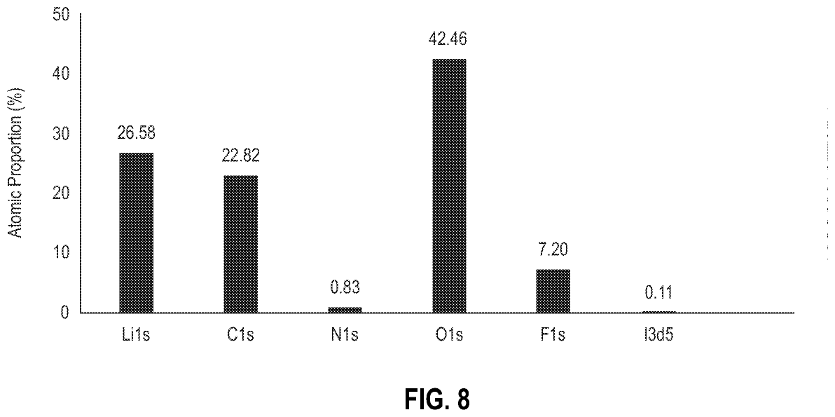

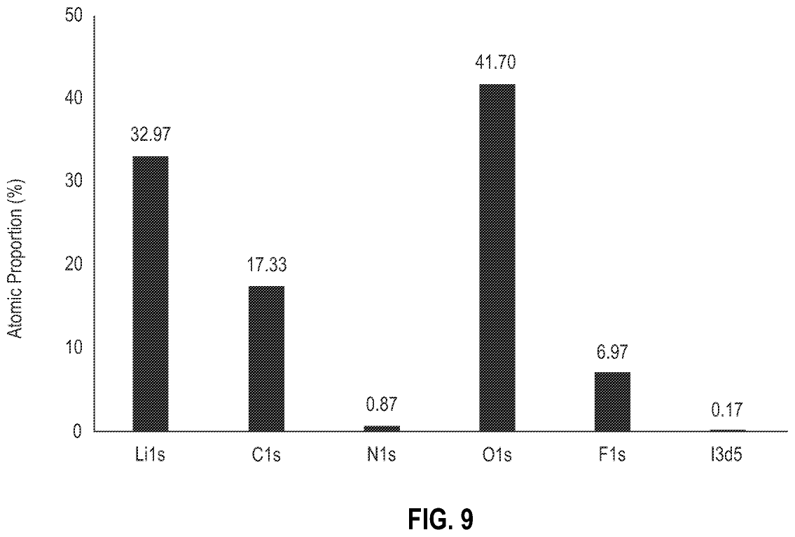

Comparative Example 2 describes the formation of an SEI layer on a Li anode, which is incorporated into a battery cell that is sealed under argon gas and cycled under pure O₂ with an electrolyte solution that includes the organic solvents DME and DOL and the salts LiTFSI and LiNO₃. FIG. 6 shows the atomic proportion of Li, C, and O on the Li anode SEI layer over the course of 30 cycles and FIG. 7 shows the atomic proportion of N, F, and I on the Li anode SEI layer over the course of the same 30 cycles. As shown there, the atomic proportions of Li, C, O, N, F, and I in the SEI layer on the Li anode surface αcur within the space of Li_{α}C_{γ}N_{δ}F_{ε}I_{ζ}O_{η}, where α=0.27-0.35; γ=0.16-0.22; δ=0.001-0.02; ε=0.004-0.09; ζ=0.0003-0.006; and η=0.43-0.48. FIG. 8 shows the atomic proportions of Li, C, O, N, F, and I after the first charge and FIG. 9 shows the atomic proportions of Li, C, O, N, F, and I after 30th charge. The change from the clean dry air in Comparative Example 1 to the pure O₂ in Comparative Example 2 produces an SEI layer with slightly more stable percentages of N, O, F, and I, but overall, the change from the clean dry air to the pure O₂ does not greatly alter the overall formation of the SEI layer.

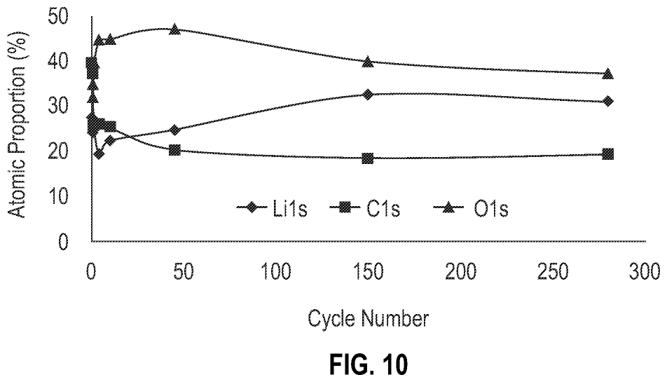

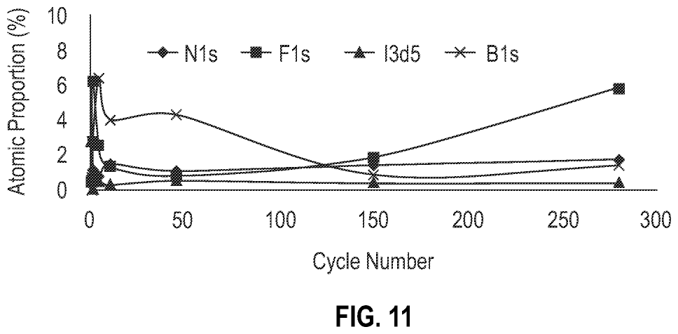

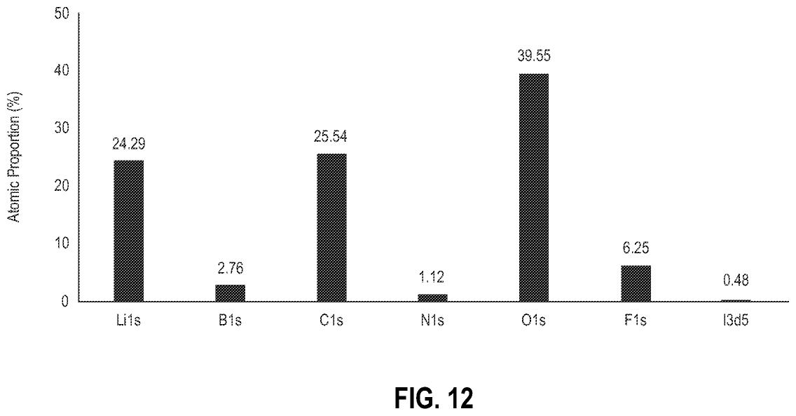

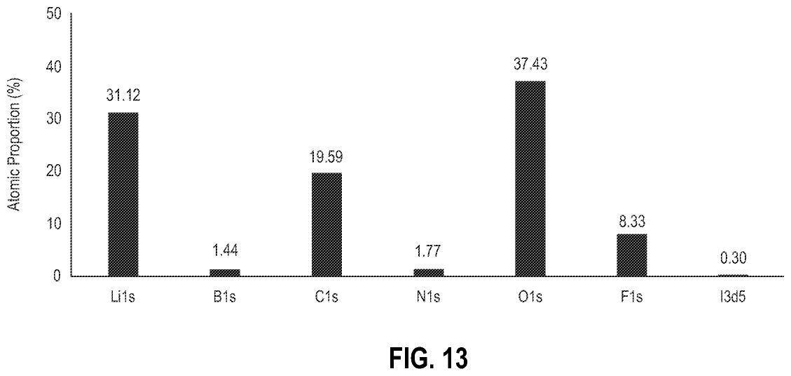

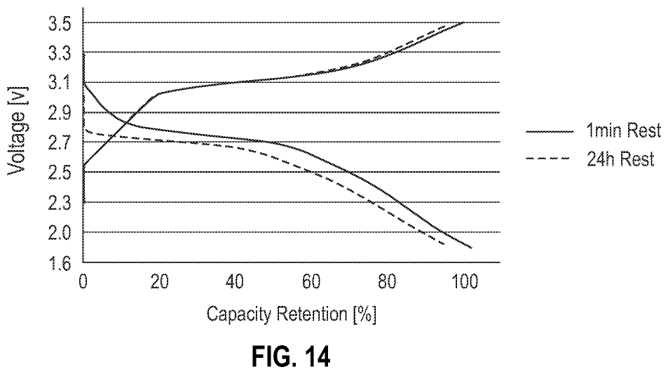

Example 1 describes the formation of an SEI layer on a Li anode, which is incorporated into a battery cell that is sealed under argon gas and cycled under pure O₂ with an electrolyte solution that includes the organic solvents DME and DOL and the salts LiTFSI, LiNO₃, and LiBOB. FIG. 10 shows the atomic proportion of Li, C, and O on the Li anode SEI layer over the course of 280 cycles and FIG. 11 shows the atomic proportion of N, F, I, and B on the Li anode SEI layer over the course of the same 280 cycles. As shown there, the atomic proportions of Li, C, O, N, F, I, and B in the SEI layer on the Li anode surface αcur within the space of Li_{α}B_{β}C_{γ}N_{δ}F_{ε}I_{ζ}O_{η}, where α=0.27-0.35; β=0.0144-0.0644; γ=0.16-0.22; δ=0.001-0.02; ε=0.004-0.09; ζ=0.0003-0.006; and η=0.43-0.48. FIG. 12 shows the atomic proportions of Li, B, C, O, N, F, and I after the first charge and FIG. 13 shows the atomic proportions of Li, B, C, O, N, F, and I after the 280th charge. As shown therein, the addition of the LiBOB to the electrolyte solution introduced several atomic percent of boron into the SEI layer. FIG. 14 shows the capacity retention of the battery cell after 1 min of rest and 24 hrs of rest at open circuit voltage. In contrast to the capacity retention of the battery shown in FIG. 5 (Comparative Example 1), which had a reduced capacity retention of ˜20% after 24 hrs of rest, the capacity retention of the battery with the LiBOB (Example 1) showed a nominal reduction of less than 10% after 24 hrs of rest.

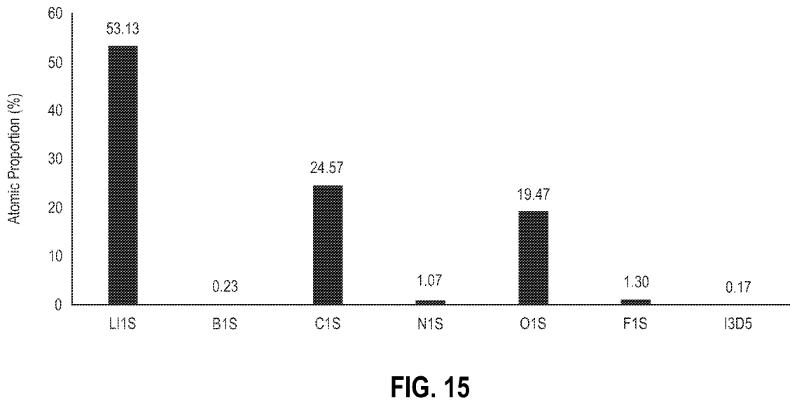

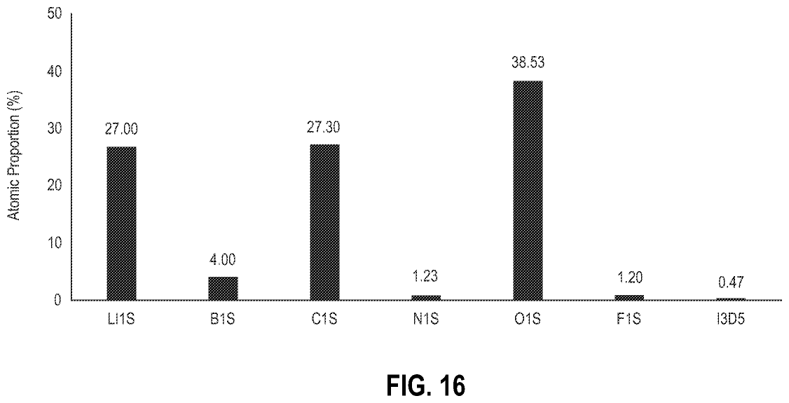

Example 2 describes the formation of an SEI layer on a Li anode after pre-soaking (also referred to herein as “pretreatment”) of the Li anode with a boric acid/dimethyl sulfoxide (BOH₃/DMSO) solution. After the pre-soaking, the Li anode is incorporated into a battery cell that is sealed and cycled under clean dry air with an electrolyte solution that includes the organic solvents DME and DOL and the salts LiTFSI and LiNO₃. The battery cell was charged and discharged for a total of 10 cycles. FIG. 15 shows the atomic proportion of Li, B, C, O, N, F, and I on the lithium surface after the pre-soaking and FIG. 16 shows the atomic proportion of Li, B, C, O, N, F, and I on the lithium surface after the 10th discharge. As shown therein, the pre-soaking of the Li anode prior to formation of the SEI layer results in a boron rich SEI that is present after the 10^{th} discharge.

In one embodiment, the SEI layer described herein may formed in-situ by incorporating additives into the electrolyte formulation (as is done in Example 1). Examples of additives that may be added to the electrolyte formulation include, without limitation, lithium nitrate, lithium bis(trifluoromethanesulfonyl)imide, lithium bis(oxolato) borate, boric acid, iodic acid, and combinations thereof.

In another embodiment, the SEI layer may be formed ex-situ by first exposing the metal anode to an oxidizing gas and then treating the oxidized metal anode with an anhydrous oxidizing acid dissolved in an aprotic solvent. Examples of oxidizing acids that may be used for the anode treatment include, without limitation, nitric acid, hydrofluoric acid, iodic acid, boric acid and combinations thereof. Examples of aprotic solvents that may dissolve the oxidizing acid include, without limitation, dimethyl sulfoxide (DMSO), 1,2-dimethoxyethane (DME), acetonitrile, carbon disulfide, and combinations thereof. The treated electrode may further be rinsed and dried prior to use in a battery cell.

In a further embodiment, the two modes of SEI layer formation described herein may be combined. For example, the two SEI layer formation processes can be combined in a single cell that includes a pretreated metal electrode and an additive laden electrolyte formulation.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### EXPERIMENTAL

The following Examples are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric. All components were obtained commercially unless otherwise indicated.

In the following Examples, all salts were dried at 150° C. inside of an argon filled glovebox and stored at 100° C. inside of the argon filled glovebox. All solvents were dried over 3 Å molecular sieves for at least 48 hours before use.

### Comparative Example 1 SEI Layer Formation with an LiTFSI, LiNO₃, DOL, and DME Electrolyte Cycled Under an Atmosphere of Clean Dry Air

An electrolyte was prepared by weighing 0.5 mmol LiTFSI and 0.02 mmol LiNO₃, and dissolving the salts into 500 μL of DME to which a further 500 μL of DOL was added. The final solution was clear, colorless, and without visible undissolved salt.

A battery stack was assembled in an atmosphere of clean dry air with 21% 02 and 79% N₂. A lithium metal anode was affixed to a stainless-steel current collector and placed in contact with a stainless-steel cell casing. 30 μL of electrolyte was applied to the lithium metal anode onto which a polyethylene-polypropylene-polyethylene separator (CELGARD® 2325; Celgard, LLC, Charlotte, N.C., USA) was placed. An additional 30 μL of electrolyte was then applied to the separator and a pre-prepared cathode containing lithium iodide, carbon, and a binder coated onto a stainless-steel substrate was placed, cathode side down, onto the stack assembly. Upon completion of the battery stack, the stack was contained in a 2032 type coin cell and the cell was sealed. The sealed cell was cycled a number of times before being deconstructed, the anode rinsed and dried, and the anode surface chemically analyzed by X-ray Photoelectron Spectroscopy (XPS). FIG. 1 shows the atomic proportions (%) of Li, C, and O on the Li anode surface over the first 30 cycles and FIG. 2 shows the atomic proportions (%) of N, F, and I on the Li anode surface layer over the same first 30 cycles. FIG. 3 shows the surface composition of Li, C, N, O, F, and I after the first charge and FIG. 4 shows the surface composition of Li, C, N, O, F, and I after the 30th charge. FIG. 5 shows the capacity retention of the battery after 1 min of rest and 24 hrs of rest at open circuit voltage.

### Comparative Example 2 SEI Layer Formation with an LiTFSI, LiNO₃, DOL, and DME Electrolyte Cycled Under an Atmosphere of Pure O₂

The electrolyte and battery stack were prepared as in Example 1, the only difference being that the battery stack was assembled under an argon atmosphere instead of an atmosphere of clean dry air. The sealed cell was cycled a number of times under a continuously supplied positive pressure of pure O₂ gas with an absolute pressure of approx. 1300 torr before being deconstructed, the anode rinsed and dried, and the anode surface chemically analyzed by XPS. FIG. 6 shows the atomic proportions (%) of Li, C, and O on the Li anode surface over the first 30 cycles and FIG. 7 shows the atomic proportions (%) of N, F, and I on the Li anode surface layer over the same first 30 cycles. FIG. 8 shows the surface composition of Li, C, N, O, F, and I after the first charge and FIG. 9 shows the surface composition of Li, C, N, O, F, and I after the 30th charge.

### Example 1 SEI Layer Formation with an LiTFSI, LiNO₃, DOL, DME, and LiBOB Electrolyte Cycled Under an Atomosphere of Clean Dry Air

The electrolyte and battery stack were prepared as in Comparative Example 1, the only difference being that LiBOB was added to the electrolyte formulation. As in Comparative Example 1, the sealed battery stack was cycled a number of times under clean dry air before being deconstructed, the anode rinsed and dried, and the anode surface chemically analyzed by XPS. FIG. 10 shows the atomic proportions (%) of Li, C, and O on the Li anode surface over the first 280 cycles and FIG. 11 shows the atomic proportions (%) of N, F, I, and B on the Li anode surface layer over the same first 280 cycles. FIG. 12 shows the surface composition of Li, B, C, N, O, F, and I after the first charge and FIG. 13 shows the surface composition of Li, B, C, N, O, F, and I after the 280^{th} charge. FIG. 14 shows the capacity retention of the battery after 1 min of rest and after 24 hrs of rest at open circuit voltage.

### Example 2 SEI Layer Formation after Boric Acid/DMSO Pretreament

A Li metal anode was affixed to a stainless-steel current collector inside of an argon filled glovebox (O₂<0.1 ppm, H₂O<0.1 ppm). A Li anode was polished with a nylon brush to remove the native surface layer and then placed in clean dry air (a gas environment of nitrogen, oxygen, or carbon dioxide could also be used) at approximately 790 torr for 5 hours to form a fresh surface film on the lithium. The lithium anode was then transferred into the argon filled glovebox and pre-soaked in a 50 mM boric acid (BOH₃) solution in dimethyl sulfoxide (DMSO) for 10 minutes after which the Li anode was dried under vacuum for at least 3 hours. After the Li anode was dried, an SEI layer was formed on the Li anode as described in Example 1. Upon completion of the battery stack, the cell was sealed and cycled for a number of times under clean dry air before being deconstructed, the anode rinsed and dried, and the anode surface chemically analyzed by XPS. FIG. 15 shows the surface composition of Li, B, C, N, O, F, and I after the pretreatment and FIG. 16 shows the surface composition of Li, C, N, O, F, and I after the 10^{th} discharge.

We claim:

1. A rechargeable battery comprising:
a metal anode;
a cathode;
an electrolyte in contact with the anode and the cathode; and
a solid electrolyte interphase (SEI) layer on a surface of the metal anode, wherein the SEI layer has a composition according to Formula (1),
M_{α}B_{β}C_{γ}N_{δ}F_{ε}X_{ζ}O_{η}, (1)
wherein,
M is a metal, B is boron, C is carbon, N is nitrogen, F is fluorine, X is a non-fluorine halogen, and O is oxygen,
α is a number in the range of 0.2-0.4,
β is a number in the range of 0.001-0.1,
γ is a number in the range of 0.15-0.25,
δ is a number in the range of 0.0-0.02,
ε is a number in the range of 0.0-0.1,
ζ is a number in the range of 0.005-0.02,
η is a number in the range of 0.40-0.60, and
α, β, γ, δ, ε, ζ, η and are selected such that the sum of α+β+γ+δ+ε+ζ+η=1.

2. The rechargeable battery of claim 1, wherein the M is selected from the group consisting of lithium (Li), sodium (Na), potassium (K), calcium (Ca), zinc (Zn), aluminum (Al), vanadium (V), iron (Fe), and combinations thereof.

3. The rechargeable battery of claim 1, wherein X is selected from the group consisting of chlorine (Cl), bromine (Br), iodine (I), astatine (At), and combinations thereof.

4. The rechargeable battery of claim 1, wherein the metal anode comprises a metal selected from the group consisting of lithium (Li), sodium (Na), potassium (K), rubidium (Rb), cesium (Cs), Francium (Fr), beryllium (B3), magnesium (Mg), calcium (Ca), aluminum (Al), and combinations thereof.

5. The rechargeable battery of claim 1, wherein the cathode comprises a halogen species selected from the group consisting of fluorine (F), chlorine (Cl), bromine (Br), iodine (I), astatine (At), and combinations thereof.

6. The rechargeable battery of claim 1, wherein the halogen species in the cathode is in the form of a metal halide that dissociates into a cation and a halide ion upon solvation.

7. The rechargeable battery of claim 1, wherein the electrolyte is a liquid electrolyte comprising as least one organic solvent and at least one salt.

8. The rechargeable battery of claim 1, wherein the organic solvent is selected from the group consisting of 1,2-dimethoxyethane (DME), tetraglyme (G4), 1,3-dioxolane (DOL), tetrahydrofuran (THF), and combinations thereof.

9. The rechargeable battery of claim 1, wherein the salt is selected from the group consisting of bis(trifluoromethanesulfonyl)imide (LiTFSI), lithium nitrate (LiNO₃), lithium bix(oxalate)-borate (LiBOB), lithium bis(fluorosulfonly)imide (LiFSI), lithium hexafluorophosphate (LiPF₆), and combinations thereof.

10. The rechargeable battery of claim 1, further comprising an oxidizing gas in contact with the electrolyte, wherein the oxidizing gas is selected from the group consisting of oxygen, air, zero air, carbon dioxide, nitric oxide, nitrogen dioxide, and combinations thereof.

11. A rechargeable battery comprising:
a metal anode;
a cathode;
an electrolyte comprising an organic solvent and a salt, wherein the electrolyte is in contact with a surface of the metal anode and a surface of the cathode;
an oxidizing gas in contact with the electrolyte, the metal anode, and the cathode; and
a solid electrolyte interphase (SEI) layer on the surface of the metal anode that is in contact with the electrolyte, wherein the SEI layer has a composition according to Formula (2),
Li_{α}B_{β}C_{γ}N_{δ}F_{ε}I_{ζ}O_{η}, (2)
wherein,
Li is lithium, B is boron, C is carbon, N is nitrogen, F is fluorine, I is iodine, and O is oxygen,
α is a number in the range of 0.2-0.4,
β is a number in the range of 0.001-0.1,
γ is a number in the range of 0.15-0.25,
δ is a number in the range of 0.0-0.02,
ε is a number in the range of 0.0-0.1,
ζ is a number in the range of 0.005-0.02,
η is a number in the range of 0.40-0.60, and
α, β, γ, δ, ε, ζ, and η are selected such that the sum of α+β+γ+δ+ε+ζ+η=1.

12. The rechargeable battery of claim 11, wherein the metal anode comprises a metal selected from the group consisting of lithium (Li), sodium (N), potassium (K), rubidium (Rb), cesium (Cs), francium (Fr) beryllium (B3), magnesium (Mg), calcium (Ca), aluminum (Al), and combinations thereof.

13. The rechargeable battery of claim 11, wherein the halogen species of the cathode is selected from the group consisting of fluorine (F), chlorine (Cl), bromine (Br), iodine (I), astatine (At), and combinations thereof.

14. The rechargeable battery of claim 1, wherein the halogen species in the cathode is in the form of a metal halide that dissociates into a cation and a halide ion upon solvation.

15. The rechargeable battery of claim 11, wherein the oxidizing gas is selected from the group consisting of air, oxygen, nitric oxide, nitrogen dioxide, and combinations thereof.

16. The rechargeable battery of claim 11, wherein the electrolyte is a liquid electrolyte comprising an organic solvent and a salt.

17. The rechargeable battery of claim 16, wherein the organic solvent is selected from the group consisting of 1,2-dimethoxyethane (DME), tetraglyme (G4), 1,3-dioxolane (DOL), tetrahydrofuran (THF), and combinations thereof.

18. The rechargeable battery of claim 16, wherein the salt is selected from the group consisting of bis(trifluoromethanesulfonyl)imide (LiTFSI), lithium nitrate (LiNO₃), lithium bix(oxalate)-borate (LiBOB), lithium bis(fluorosulfonly)imide (LiFSI), lithium hexafluorophosphate (LiPF₆), and combinations thereof.

19. A rechargeable battery comprising:
a lithium anode;
a cathode comprising lithium iodide integrated into a porous carbon material selected from the group consisting of carbon cloth, carbon paper, carbon felt, carbon nanotubes, carbon nanotube arrays, carbon fibers, activated carbon, carbon black, graphene, graphene oxide, reduced graphene oxide, 3D graphene skeleton, pyrolytic graphite, and combinations thereof;
a liquid electrolyte comprising an organic solvent and a salt, wherein the electrolyte is in contact with a surface of the lithium anode and a surface of the cathode;
an oxidizing gas in contact with the electrolyte, the metal anode, and the cathode, wherein the oxidizing gas is selected from the group consisting of air, oxygen, nitric oxide, nitrogen dioxide, and combinations thereof; and
a solid electrolyte interphase (SEI) layer on the surface of the metal anode that is in contact with the electrolyte, wherein the SEI has a composition according to Formula (2),
Li_{α}B_{β}C_{γ}N_{δ}F_{ε}I_{ζ}O_{η} (2)
wherein,
Li is lithium, B is boron, C is carbon, N is nitrogen, F is fluorine, I is iodine, and O is oxygen,
α is an integer in the range of 0.2-0.4,
β is an integer in the range of 0.001-0.1,
γ is an integer in the range of 0.15-0.25,
δ is an integer in the range of 0.0-0.02,
ε is an integer in the range of 0.0-0.1,
ζ is an integer in the range of 0.005-0.02,
η is an integer in the range of 0.40-0.60, and
α, β, γ, δ, ε, ζ, and η are selected such that the sum of α+β+γ+δ+ε+ζ+η=1.

20. The rechargeable battery of claim 19, wherein the organic solvent is selected from the group consisting of 1,2-dimethoxyethane (DME), tetraglyme (G4), 1,3-dioxolane (DOL), tetrahydrofuran (THF), and combinations thereof.

21. The rechargeable battery of claim 19, wherein the salt is selected from the group consisting of bis(trifluoromethanesulfonyl)imide (LiTFSI), lithium nitrate (LiNO₃), lithium bix(oxalate)-borate (LiBOB), lithium bis(fluorosulfonly)imide (LiFSI), lithium hexafluorophosphate (LiPF₆), and combinations thereof.

22. A method of fabricating a rechargeable battery comprising:
assembling a battery stack in the presence of an oxidizing gas, wherein the battery stack comprises,
a metal anode,
a cathode, wherein a surface of the metal anode faces a surface of the cathode, and
an electrolyte comprising an organic solvent and a salt, wherein the electrolyte is in contact with the facing surfaces of the metal anode and the cathode;
sealing the battery stack within a battery cell case to form the rechargeable battery; and
introducing an electric current to the rechargeable battery, wherein initial charge of the rechargeable battery forms a solid-electrolyte interphase (SEI) layer on the surface of the metal anode facing the surface of the cathode, wherein the SEI layer has a composition according to Formula (1),
M_{α}B_{β}C_{γ}N_{δ}F_{ε}X_{ζ}O_{η}, (1)
wherein,
M is a metal, B is boron, C is carbon, N is nitrogen, F is fluorine, X is a non-fluorine halogen species, and O is oxygen,
α is a number in the range of 0.2-0.4,
β is a number in the range of 0.001-0.1,
γ is a number in the range of 0.15-0.25,
δ is a number in the range of 0.0-0.02,
ε is a number in the range of 0.0-0.1,
ζ is a number in the range of 0.005-0.02,
η is a number in the range of 0.40-0.60, and
α, β, γ, δ, ε, ζ, and η are selected such that the sum of α+β+γ+δ+ε+ζ+η=1.

23. The rechargeable battery of claim 19, wherein the organic solvent is selected from the group consisting of 1,2-dimethoxyethane (DME), tetraglyme (G4), 1,3-dioxolane (DOL), tetrahydrofuran (THF), and combinations thereof.

24. The rechargeable battery of claim 19, wherein the salt is selected from the group consisting of bis(trifluoromethanesulfonyl)imide (LiTFSI), lithium nitrate (LiNO₃), lithium bix(oxalate)-borate (LiBOB), lithium bis(fluorosulfonly)imide (LiFSI), lithium hexafluorophosphate (LiPF₆), and combinations thereof.

25. A method of fabricating a rechargeable battery comprising:
assembling a battery stack in the presence of an oxidizing gas, wherein the battery stack comprises,
a lithium anode,
a cathode comprising lithium iodide integrated into a porous carbon material, wherein a surface of the metal anode faces a surface of the cathode, and
an electrolyte comprising an organic solvent and a salt, wherein the electrolyte is in contact with the facing surfaces of the metal anode and the cathode;
sealing the battery stack within a battery cell case to form the rechargeable battery; and
introducing an electric current to the rechargeable battery, wherein initial charge of the rechargeable battery forms a solid-electrolyte interphase (SEI) layer on the surface of the metal anode facing the surface of the cathode, wherein the SEI layer has a composition according to Formula (2),
Li_{α}B_{β}C_{γ}N_{δ}F_{ε}I_{ζ}O_{η}, (2)
wherein,
Li is lithium, B is boron, C is carbon, N is nitrogen, F is fluorine, I is iodine, and O is oxygen,
α is an integer in the range of 0.2-0.4,
β is an integer in the range of 0.001-0.1,
γ is an integer in the range of 0.15-0.25,
δ is an integer in the range of 0.0-0.02,
ε is an integer in the range of 0.0-0.1,
ζ is an integer in the range of 0.005-0.02,
η is an integer in the range of 0.40-0.60, and
α, β, γ, δ, ε, ζ, and η are selected such that the sum of α+β+γ+δ+ε+ζ+η=1.
